(19) United States
(12) Patent Application Publication
(10) Pub. No.: US 2020/0211388 A1
(43) Pub. Date: Jul. 2, 2020

(54) AUGMENTED REALITY BASED DRIVER GUIDANCE SYSTEM

(71) Applicant: Visteon Global Technologies, Inc., Van Buren Township, MI (US)

(72) Inventors: Umang Salgia, Nigdi (IN); Vibhor Deshmukh, Wakad (IN); Chanthu Nair, Wakad (IN); Chirag Ahuja, Rohini (IN)

(21) Appl. No.: 16/732,892

(22) Filed: Jan. 2, 2020

(30) Foreign Application Priority Data
Jan. 2, 2019 (IN) 201941000101

(51) Int. Cl. G08G 1/0968; G01C 21/32; G01C 21/36; G02B 27/01

(52) U.S. Cl. CPC G08G 1/096855; G01C 21/32; G01C 21/3629; G01C 21/365; G01C 21/3652; G02B 2027/0187; G01C 21/3664; G01C 21/3694; G01C 21/367; G02B 27/0179; G01C 21/362

(57) ABSTRACT

A method for providing augmented reality based driver assistance. includes: receiving, from a plurality of sensors, information corresponding to an environment external to a vehicle; receiving position information indicating a position of the vehicle; generating an environmental model of the environment external to the vehicle; analyzing data associated with the environmental model; identifying information relevant to a current situation of the vehicle; monitoring at least one driver related parameter of a driver of the vehicle; generating actionable information based on the information relevant to the current situation of the vehicle and the at least one driver related parameter; generating an output based on the actionable information; and outputting the actionable information.

### CROSS-REFERENCES TO RELATED APPLICATIONS

This patent application claims priority to Indian Provisional Patent Application Serial No. 201941000101, filed Jan. 2, 2019, which is incorporated herein by reference in its entirety.

### FIELD

The present disclosure relates to the field of driver assist or driver guidance systems. In particular, the present disclosure relates to an augmented reality based driver assist or driver guidance system.

### BACKGROUND

Driver assist systems are known in the art. Advanced driver-assistance systems, or ADAS, are systems that assist a driver in vehicle operation. More specifically, ADAS systems are designed with a safe and easily accessible human-machine interface for increasing car safety and more generally road safety. The manner that the conventional ADAS systems operate is that systems use sensors to sense the environment or surroundings of the vehicle being driven to provide the driver of the vehicle with the information about the same. A drawback, however, of the conventional ADAS systems is that the driver is provided with a lot of information, relevant as well as irrelevant, with respect to a particular situation. The driver, has to navigate through all of this information to decide which information is useful at that particular moment of time. This can slow down the driver's decision making process in some very critical moments, which can be a cause of accidents, and as such is not at all desired.

There is, therefore, felt a need of a driver assistance or driver guidance system that is designed to provide the driver with targeted information pertaining to a particular situation and ensure that the driver is not provided with any irrelevant information pertaining that particular situation.

### SUMMARY

This disclosure relates generally to augmented reality based driver guidance systems.

An aspect of the disclosed embodiments includes an augmented reality based driver assist system. The system includes a processor and a memory. The memory includes instructions that, when executed by the processor, cause the processor to: receive, from a plurality of sensors, information corresponding to an environment external to a vehicle; receive position information indicating a position of the vehicle; generate an environmental model of the environment external to the vehicle; analyze data associated with the environmental model; identify information relevant to a current situation of the vehicle; monitor at least one driver related parameter of a driver of the vehicle; generate actionable information based the information relevant to the current situation of the vehicle and the at least one driver related parameter; generate an output based on the actionable information; and output the actionable information.

Another aspect of the disclosed embodiments includes a method for providing augmented reality based driver assistance. The method includes: receiving, from a plurality of sensors, information corresponding to an environment external to a vehicle; receiving position information indicating a position of the vehicle; generating an environmental model of the environment external to the vehicle; analyzing data associated with the environmental model; identifying information relevant to a current situation of the vehicle; monitoring at least one driver related parameter of a driver of the vehicle; generating actionable information based on the information relevant to the current situation of the vehicle and the at least one driver related parameter; generating an output based on the actionable information; and outputting the actionable information.

Another aspect of the disclosed embodiments includes a system that includes a processor and a memory. The memory includes instructions that, when executed by the processor, cause the processor to: generate an environmental model of an environment external to a vehicle based on at least one environmental measurement corresponding to the environment external to the vehicle and a position of the vehicle; identify information relevant to a current situation of the vehicle, using the environmental model; monitor at least one operator related parameter of an operator of the vehicle; generate actionable information based the information relevant to the current situation of the vehicle and the at least one driver related parameter; and output the actionable information.

### BRIEF DESCRIPTION OF DRAWING

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a block diagram of an augmented reality based driver guidance system according to the principles of the present disclosure.

FIG. 3 is a flow diagram generally illustrating an augmented reality based driver assistance method according to the principles of the present disclosure.

### DETAILED DESCRIPTION

The following discussion is directed to various embodiments. Although one or more of these embodiments may be preferred, the embodiments disclosed should not be interpreted, or otherwise used, as limiting the scope of the disclosure. In addition, one skilled in the art will understand that the following description has broad application, and the discussion of any embodiment is meant only to be exemplary of that embodiment, and not intended to intimate that the scope of the disclosure is limited to that embodiment.

As discussed previously, the conventional driver assist systems provide the driver with information that is relevant to a particular driving situation along with a lot of other information that may not be irrelevant to that particular driving situation. This is because the conventional systems do not take into account the cognitive load that is on the driver in a particular driving situation, while the driver has to navigate thru the plethora of information bits provided by the conventional systems to get the relevant information.

In order to overcome the aforementioned disadvantage, the present disclosure describes, among other things, an augmented reality based driver guidance system that detects various characteristics of a vehicle and/or the environment proximate the vehicle as well as takes into account the cognitive load of the driver. The system may provide targeted information to the driver pertaining to a particular driving situation. The targeted information may include information relevant to a particular driving situation excluding everything else that is not relevant to that particular driving situation.

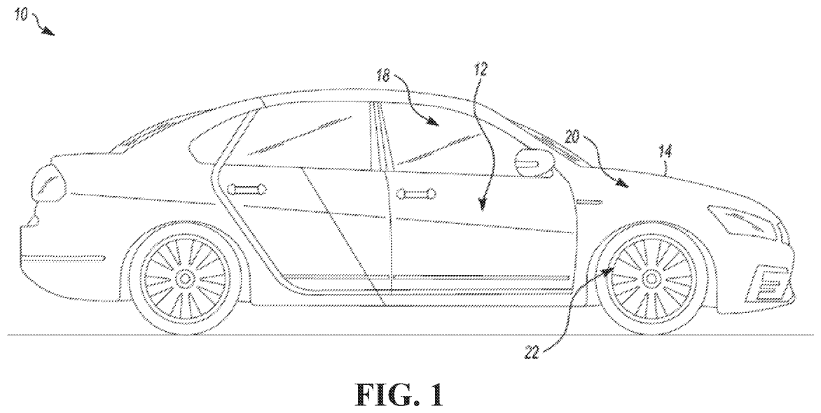

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In the context of driving automation, the vehicle 10 may be a semi-automated or a fully automated. Under semi-automated driving automation, the vehicle 10 may perform automated driving operations which may be supervised by an operator or other occupant of the vehicle 10 or may be limited in nature, such as park assist. Under fully automated driving automation, the vehicle 10 may perform automated driving operations which may be unsupervised by an operator or other occupant of the vehicle 10 and may be independent in nature, such as complete navigation from point A to point B without supervision or control by the operator or other occupant.

The vehicle 10 may include any suitable level of driving automation, such as defined by the society of automotive engineers (e.g., SAE J3016). For example, the vehicle 10 may include features of level 0 automation, level 1 automation, or level 2 automation. For example, the vehicle 10 may include one or more features that assist an operator of the vehicle 10, while requiring the operator of the vehicle 10 to drive the vehicle 10 or at least supervise the operation of the one or more features. Such features may include cruise control, adaptive cruise control, automatic emergency braking, blind spot warning indicators, lane departure warning indicators, lane centering, other suitable features, or a combination thereof.

In some embodiments, the vehicle 10 may include features of level 3 automation, level 4 automation, or level 5 automation. For example, the vehicle 10 may include one or more features that control driving operations of the vehicle 10, without operator or other occupant interaction or supervision of the one or more features by the operator or other occupant. Such features may include a traffic jam chauffeur, limited scenario driverless features (e.g., features that allow the vehicle 10 to operate autonomously, without operator or other occupant interaction or supervision, in specific situations, such as specific route, or other specific situations), fully autonomous driving features (e.g., features that allow the vehicle 10 to drive completely autonomously in every scenario, without operator or other occupant interaction or supervision), or other suitable features. The vehicle 10 may include additional or fewer features than those generally illustrated and/or disclosed herein.

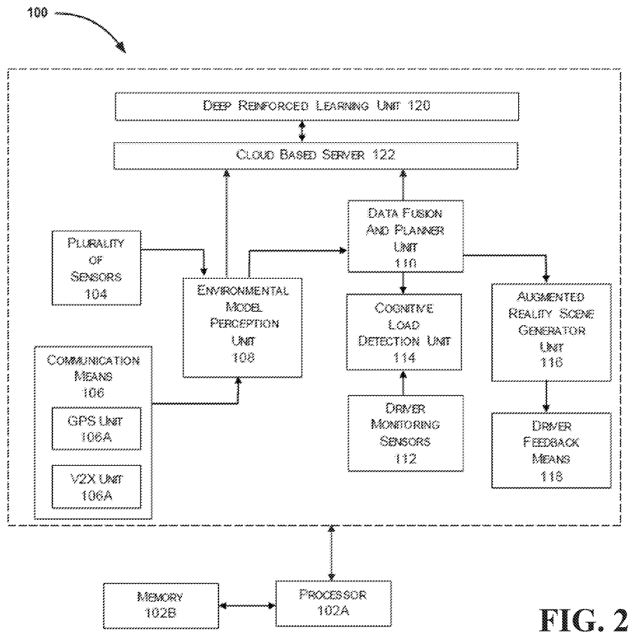

The vehicle 10 may include an augmented reality based driver guidance system, such as the system 100 as is generally illustrated in FIG. 2 (hereinafter referred to as system 100

The system 100 can be employed in a vehicle, such as the vehicle 10, in accordance with some embodiments. The system 100 comprises a processor 102A. In some embodiments, the processor 102 can be the electronic control unit of the vehicle 10. The processor 102 may include any suitable processor, such as those described herein. The system 100 further comprises a memory 102B including computer program code(s) or instructions for one or more programs that, when executed by the processor 102A, cause the processor 102 to generate system processing commands for operating the system 100.

The system 100 further comprises a plurality of sensors 104. The plurality of sensors 104 include, but are not limited to one or more image capturing units positioned at strategic locations on the vehicle 10, radars, LIDARs, and inertial measurement units. The system 100 may include communication means 106. The communications means 106 may include a GPS unit 106A and a vehicle-to-everything (V2X) communication 106B. The plurality of sensors 104 are configured to sense the environment or the surroundings of the vehicle 10, whereas the communication means 106 communicate the position of the vehicle 10 as well as facilitate the communication from a vehicle to any entity that may affect the vehicle 10, and vice versa.

The system 100 may include an environmental model perception unit 108. The environmental model perception unit 108 is communicatively coupled to the plurality of sensors 104 and the communication means 106. The environmental model perception unit 108 takes inputs from the plurality of sensors 104 and the communication means 106 for creating an environmental model of the surroundings of the vehicle 10, which includes the presence of static and dynamic objects, what the objects are doing, and the precise location and status of the vehicle 10. Furthermore, information from the communication means 106 provide the map and navigation data (GPS unit 106A) along with the weather conditions and certain cloud services provide the information that can be critical to a certain driving situation.

The system 100 may include a data fusion and planner unit 110. The data fusion and planner unit 110 is communicatively coupled to the environmental model perception unit 108. More specifically, the data pertaining to the environmental model generated by the environmental model perception unit 108 is fed to the data fusion and planner unit 110. The function of the data fusion and planner unit 110 is to analyze the data pertaining to the environmental model generated by the environmental model perception unit 108 and determine the relevant information and actions for the driver in the current situation.

The system 100 may include a plurality of driver monitoring sensors 112. The plurality of driver monitoring sensors 112 are communicatively coupled to a cognitive load detection unit 114, which in turn is communicatively coupled to the data fusion and planner unit 110. More specifically, the cognitive load detection unit 114 takes input from the data fusion and planner unit 110 as well as the plurality of driver monitoring sensors 112. The plurality of driver monitoring sensors 112 are configured to sense driver state, emotions, gaze, focus, ability to process and comprehend information, expressions and changes in micro expressions, hand movements, and gestures, head movements, and so on. Based on the inputs from the plurality of driver monitoring sensors 112 and the actions suggested by the data fusion and planner unit 110, the cognitive load detection unit 114 provides an actionable plan containing only the most relevant information while discarding or hiding the irrelevant information.

The system 100 may include an augmented reality scene generator unit 116. The augmented reality scene generator unit 116 is communicatively coupled to the data fusion and planner unit 110 and the cognitive load detection unit 114. The augmented reality scene generator unit 116 receives the input from the data fusion and planner unit 110 and the cognitive load detection unit 114 to generate the final information presentation to the driver based on the inputs from the data fusion and planner unit 110 and the cognitive load detection unit 114.

The augmented reality scene generator unit 116 is further coupled to a plurality of driver feedback means 118, which include but are not limited to, a heads up display, a central information display (CID), audible feedback, light feedback, haptic feedback, and so on. For example, the augmented reality scene generator unit 116 may be configured to generate actionable information that includes visual feedback information, audible feedback information, haptic feedback information, other suitable information, or a combination thereof. The augmented reality scene generator unit 116 may be configured to output, using a visual output (e.g., such as those described herein), an audible output (e.g., such as a speaker), a haptic output (e.g., such as an actuator in a vehicle seat, floor, or other suitable location), other suitable output, or a combination thereof.

As such, using the components so far described with reference to the system 100, a clear and concise actionable plan is provided to the driver by the use of the aforementioned components of the system 100.

The system 100 may include a deep reinforced learning unit 120. The deep reinforced learning unit 120 is configured to receive anonymized data from the vehicle 10 for each situation experienced by the driver. More specifically, the aforementioned data is captured and sent to a cloud based server 122 for offline training of the system 100. In some embodiments, the anonymized data includes, but not limited to, the environmental model, the driver state just before and after a driving situation, changes in micro expression and gaze, action provided to driver, action taken by driver, outcome, and so on. This real life data is augmented with synthesized system data to enhance the operation and performance of the system 100.

In some embodiments, the system 100 serves as an agent in the world of where the vehicle 10 is being driver. The vehicle 10 is surrounded by variety of other objects, for example, vehicles, pedestrians, and other objects like traffic signals and different lanes. These objects can either be static objects that do not move or dynamic objects that move with a variation in their motion models. The actions that the system 100 can perform include, but are not limited to, the set display objects such as navigation, collision warning, vehicle diagnostic warnings, blind spot warning, and the like.

The system states are the states the system 100 can be in. The state variables are continuous, for example, the vehicle speed, distance from other vehicles, pose on the road, and the like. The combination of different such variables defines a state, which may have various combinations, and thus assisting the system 100 identify the best action that the driver should take while ending up into that state.

In some embodiments, the driver may provide the feedback about the action taken by or recommended by the system 100, which can be modelled as Rewards (R). In order to provide the feedback to the system 100, the system 100 may be configured to receive hand gestures, voice commands, micro expressions, human machine interfaces, and so on to collect the feedback of the corresponding action. The system 100 may then assign a weight value to the action in terms of rewards. While optimizing the quality of action in a particular state using the rewards collected, an optimal set of actions can be determined or calculated by the system 100 when the system 100 is in a particular state or when transitioning from one state to another.

In some embodiments, the system 100 may perform the methods described herein. However, the methods described herein as performed by system 100 are not meant to be limiting, and any type of software executed on a controller can perform the methods described herein without departing from the scope of this disclosure. For example, a controller, such as a processor executing software within a computing device, can perform the methods described herein.

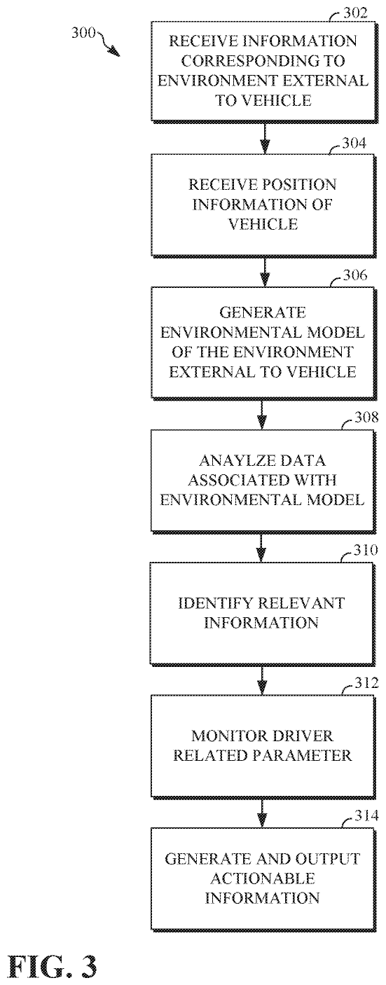

FIG. 3 is a flow diagram generally illustrating an augmented reality based driver assistance method 300 according to the principles of the present disclosure. At 302, the method 300 receives information corresponding to an environment external to a vehicle. For example, the processor 102 receives, from a plurality of sensors, information corresponding to an environment external to a vehicle 10.

At 304, the method 300 receives position information of the vehicle. For example, the processor 102 receives position information indicating a position of the vehicle 10.

At 306, the method 300 generates environmental model of the environment external to the vehicle. For example, the processor 102 generates an environmental model of the environment external to the vehicle 10.

At 308, the method 300 analyzes data associated with the environmental model. For example, the processor 102 analyzes data associated with the environmental model.

At 310, the method 300 identifies relevant information. For example, the processor 102 identifies information relevant to a current situation of the vehicle 10.

At 312, the method 300 monitors a driver related parameter. For example, the processor 102 monitors at least one driver related parameter of a driver of the vehicle 10.

At 314, the method 300 generates and outputs actionable information. For example, the processor 102 generates actionable information based on the information relevant to the current situation of the vehicle 10 and the at least one driver related parameter. The processor 102 generates an output based on the actionable information. The processor 102 outputs the actionable information

In some embodiments, an augmented reality based driver assist system includes a processor and a memory. The memory includes instructions that, when executed by the processor, cause the processor to: receive, from a plurality of sensors, information corresponding to an environment external to a vehicle; receive position information indicating a position of the vehicle; generate an environmental model of the environment external to the vehicle; analyze data associated with the environmental model; identify information relevant to a current situation of the vehicle; monitor at least one driver related parameter of a driver of the vehicle; generate actionable information based the information relevant to the current situation of the vehicle and the at least one driver related parameter; generate an output based on the actionable information; and output the actionable information.

In some embodiments, the instructions further cause the processor to receive data used to generate the environmental model from a cloud based server. In some embodiments, the plurality of sensors includes at least one of an image capturing unit, a radar device, a LIDAR device, and an inertial measurement unit. In some embodiments, the instructions further cause the processor to receive the position information from one of a global position system and a vehicle-to-everything communication unit. In some embodiments, the at least one driver related parameter includes at least one of a driver state, emotions, gaze, focus, ability to process and comprehend information, expressions and changes in micro expressions, hand movements, gestures, and head movements. In some embodiments, the instructions further cause the processor to output the actionable information to a heads up display of the vehicle. In some embodiments, the instructions further cause the processor to output the actionable information to a central information display. In some embodiments, the actionable information includes audible information. In some embodiments, the actionable information includes haptic feedback.

In some embodiments, a method for providing augmented reality based driver assistance includes: receiving, from a plurality of sensors, information corresponding to an environment external to a vehicle; receiving position information indicating a position of the vehicle; generating an environmental model of the environment external to the vehicle; analyzing data associated with the environmental model; identifying information relevant to a current situation of the vehicle; monitoring at least one driver related parameter of a driver of the vehicle; generating actionable information based on the information relevant to the current situation of the vehicle and the at least one driver related parameter; generating an output based on the actionable information; and outputting the actionable information.

In some embodiments, the method also includes receiving data used to generate the environmental model from a cloud based server. In some embodiments, the plurality of sensors includes at least one of an image capturing unit, a radar device, a LIDAR device, and an inertial measurement unit. In some embodiments, receiving the position information includes receiving the position information from one of a global position system and a vehicle-to-everything communication unit. In some embodiments, the at least one driver related parameter includes at least one of a driver state, emotions, gaze, focus, ability to process and comprehend information, expressions and changes in micro expressions, hand movements, gestures, and head movements. In some embodiments, the method also includes outputting the actionable information includes outputting the actionable information to a heads up display of the vehicle. In some embodiments, the method also includes outputting the actionable information includes outputting the actionable information to a central information display. In some embodiments, the actionable information includes audible information. In some embodiments, the actionable information includes haptic feedback.

In some embodiments, a system includes a processor and a memory. The memory includes instructions that, when executed by the processor, cause the processor to: generate an environmental model of an environment external to a vehicle based on at least one environmental measurement corresponding to the environment external to the vehicle and a position of the vehicle; identify information relevant to a current situation of the vehicle, using the environmental model; monitor at least one operator related parameter of an operator of the vehicle; generate actionable information based the information relevant to the current situation of the vehicle and the at least one driver related parameter; and output the actionable information.

In some embodiments, the at least one operator related parameter includes at least one of operator state.

Although embodiments for system and method for a method for controlling transmission of a concrete mixer vehicle have been described in language specific to structural features and/or methods, it is to be understood that the systems and methods described herein are not necessarily limited to the specific features or methods described. Rather, the specific features and methods are disclosed as exemplary embodiments of the system and the method described herein.

The above discussion is meant to be illustrative of the principles and various embodiments of the present disclosure. Numerous variations and modifications will become apparent to those skilled in the art once the above disclosure is fully appreciated.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. The term “processor” should be understood as encompassing any of the foregoing hardware, either singly or in combination. The terms “signal” and “data” are used interchangeably.

For example, one or more embodiments can include any of the following: packaged functional hardware unit designed for use with other components, a set of instructions executable by a controller (e.g., a processor executing software or firmware), processing circuitry configured to perform a particular function, and a self-contained hardware or software component that interfaces with a larger system, an application specific integrated circuit (ASIC), a Field Programmable Gate Array (FPGA), a circuit, digital logic circuit, an analog circuit, a combination of discrete circuits, gates, and other types of hardware or combination thereof, and memory that stores instructions executable by a controller to implement a feature.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

We claim:

1. An augmented reality based driver assist system comprising:
a processor;
a memory that includes instructions that, when executed by the processor, cause the processor to:
receive, from a plurality of sensors, information corresponding to an environment external to a vehicle;
receive position information indicating a position of the vehicle;
generate an environmental model of the environment external to the vehicle;
analyze data associated with the environmental model;
identify information relevant to a current situation of the vehicle;
monitor at least one driver related parameter of a driver of the vehicle;
generate actionable information based the information relevant to the current situation of the vehicle and the at least one driver related parameter;
generate an output based on the actionable information; and
output the actionable information.

2. The system of claim 1, wherein the instructions further cause the processor to receive data used to generate the environmental model from a cloud based server.

3. The system of claim 1, wherein the plurality of sensors includes at least one of an image capturing unit, a radar device, a LIDAR device, and an inertial measurement unit.

4. The system of claim 1, wherein the instructions further cause the processor to receive the position information from one of a global position system and a vehicle-to-everything communication unit.

5. The system of claim 1, wherein the at least one driver related parameter includes at least one of a driver state, emotions, gaze, focus, ability to process and comprehend information, expressions and changes in micro expressions, hand movements, gestures, and head movements.

6. The system of claim 1, wherein the instructions further cause the processor to output the actionable information to a heads up display of the vehicle.

7. The system of claim 1, wherein the instructions further cause the processor to output the actionable information to a central information display.

8. The system of claim 1, wherein the actionable information includes audible information.

9. The system of claim 1, wherein the actionable information includes haptic feedback.

10. A method for providing augmented reality based driver assistance, the method comprising:
receiving, from a plurality of sensors, information corresponding to an environment external to a vehicle;
receiving position information indicating a position of the vehicle;
generating an environmental model of the environment external to the vehicle;
analyzing data associated with the environmental model;
identifying information relevant to a current situation of the vehicle;
monitoring at least one driver related parameter of a driver of the vehicle;
generating actionable information based on the information relevant to the current situation of the vehicle and the at least one driver related parameter;
generating an output based on the actionable information; and
outputting the actionable information.

11. The method of claim 10, further comprising receiving data used to generate the environmental model from a cloud based server.

12. The method of claim 10, wherein the plurality of sensors includes at least one of an image capturing unit, a radar device, a LIDAR device, and an inertial measurement unit.

13. The method of claim 10, wherein receiving the position information includes receiving the position information from one of a global position system and a vehicle-to-everything communication unit.

14. The method of claim 10, wherein the at least one driver related parameter includes at least one of a driver state, emotions, gaze, focus, ability to process and comprehend information, expressions and changes in micro expressions, hand movements, gestures, and head movements.

15. The method of claim 10, wherein outputting the actionable information includes outputting the actionable information to a heads up display of the vehicle.

16. The method of claim 10, wherein outputting the actionable information includes outputting the actionable information to a central information display.

17. The method of claim 10, wherein the actionable information includes audible information.

18. The method of claim 10, wherein the actionable information includes haptic feedback.

19. A system comprising:
a processor;
a memory that includes instructions that, when executed by the processor, cause the processor to:
generate an environmental model of an environment external to a vehicle based on at least one environmental measurement corresponding to the environment external to the vehicle and a position of the vehicle;
identify information relevant to a current situation of the vehicle, using the environmental model;
monitor at least one operator related parameter of an operator of the vehicle;
generate actionable information based the information relevant to the current situation of the vehicle and the at least one driver related parameter; and
output the actionable information.

20. The system of claim 19, wherein the at least one operator related parameter includes at least one of operator state.
